(19) United States
(12) Patent Application Publication
(10) Pub. No.: US 2005/0154593 A1
(43) Pub. Date: Jul. 14, 2005

(54) Method and apparatus employing electromyographic sensors to initiate oral communications with a voice-based device

(75) Inventor: Richard J. Denatale, Wake Forest, NC (US)

Correspondence Address: WILLIAMS, MORGAN & AMERSON/LUCENT, 10333 RICHMOND, SUITE 1100, HOUSTON, TX, 77042, US

(73) Assignee: International Business Machines Corporation, Armonk, NY (US)

(21) Appl. No.: 10/756,869

(22) Filed: Jan. 14, 2004

(51) Int. Cl. G10L 11/00

(52) U.S. Cl. 704/275

(57) ABSTRACT

A user interface for an electronic device and a method for interfacing with an electronic device are disclosed. The user interface includes a sensor and an interface. The sensor is capable of sensing a physical movement of a user associated with an oral communication and generating an indication thereof. The sensor can then provide the indication to the electronic device through the interface. The method comprises sensing a physical movement of a user and indicating to an electronic device an initiation of an oral communication responsive to the sensing of the physical movement.

### BACKGROUND OF THE INVENTION

1. Field of the Invention

This invention relates generally to voice-based systems, and, more particularly, to initiating an oral communication with a voice-based system.

2. Description of the Related Art

Humans interface with a variety of electronic devices in a variety of ways. The way a human interfaces with the device depends largely on the function of the device. For instance, computers typically rely at some point on data input from a user, and historically this input has come through a keyboard, a mouse, or some other type of peripheral. Mobile phones, however, not only receive input through a keypad, but also orally through a microphone. The common denominator, however, is that the user interfaces with the device to impart information on which the device acts.

There is a perceptible trend in interface technology to “hands-free” interfaces. There are a variety of circumstances in which a person may need or want to interface with an electronic device without extensive physical manipulation or even contact. For instance, an automobile driver may prefer not to have to manually dial a phone number, or use manual controls to operate devices such as navigation systems while driving a car for safety reasons. Alternatively, a physically disabled person may have great difficulty in manipulating traditional computing peripheral devices such as a keyboard and a mouse. Some physically disabled people may not be able to physically manipulate these kinds of peripheral devices at all. A hands-free interface greatly boosts the utility of the respective electronic devices in these circumstances.

Recent advances in voice-based technology have accelerated the trend toward hands-free interfaces. Historically, voice-based technology, including voice recognition technology, performed very poorly, if at all. Some of this difficulty results from the language itself. Each language has its own rules, some of them relatively complex, for grammar, syntax, pronunciation, spelling, etc., so that individual applications were typically needed for different languages. This hampered the versatility of the applications. Some of the difficulty resulted from speech. Even where two people speak the same language, they may speak it very differently. The classic exemplar of this fact is the differences in the English spoken in the United States and that spoken in England. However, more subtly, speech is commonly a function not only of the language, but also factors such as dialects, idioms, geographical location, etc. Another problem arises when voice-based systems are used in noisy environments such as within a vehicle or on a factory floor.

Advances in computing technology have contributed significantly to the advances in voice-based systems. The computational power of electronic devices has increased dramatically while the size of the circuitry from which such power emanates has decreased dramatically. Thus, electronic devices continually become smaller with more computationally powerful. This permits designers to employ more powerful and sophisticated software algorithms to process the oral input and obtain a reasonably accurate result.

However, despite the recent advances, interfacing with modern-day electronic devices often requires manual intervention from the user. For example, initiating the interface still typically requires some manual interface. One common implementation is what is known as a “push-to-talk” switch that the user physically manipulates. For a mobile phone, the switch is usually located on the cord of a headset plugged into the telephone. For a computing apparatus, the switch may be a programmed hot key on a keyboard or a clickable button in a graphical user interface displayed to the user. Either way, the electronic device is passive, i.e., it does not detect the initiation of the session—the user has to manually initiate a session.

The present invention is directed to overcoming, or at least reducing the effects of, one or more of the problems set forth above.

### SUMMARY OF THE INVENTION

The invention is a user interface for an electronic device and a method for interfacing with an electronic device. The user interface includes a sensor and an interface. The sensor is capable of sensing a physical movement of a user associated with an oral communication and generating an indication thereof. The sensor can then provide the indication to the electronic device through the interface. The method comprises sensing a physical movement of a user and indicating to an electronic device an initiation of an oral communication responsive to the sensing of the physical movement.

### BRIEF DESCRIPTION OF THE DRAWINGS

The invention may be understood by reference to the following description taken in conjunction with the accompanying drawings, in which like reference numerals identify like elements, and in which:

FIG. 1 depicts a first embodiment of a system, in accordance with the present invention;

FIG. 2 depicts one embodiment of a headset that may be employed in the system of FIG. 1;

FIG. 3 illustrates a functional block diagram of an electronic device that is employed in the system of FIG. 1;

FIG. 4 depicts a second embodiment of the present invention in which the headset interfaces with a computing apparatus over a wireless communications link; and

FIG. 5 depicts a third embodiment of the present invention in which a microphone is mounted to an electronic device.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

The present invention in its various aspects and embodiments comprises, as is discussed more fully below, a sensor capable of sensing a physical movement of a user associated with an oral communication and generating an indication thereof and an interface through which the sensor can communicate the indication to the electronic device. In use, the sensor senses a physical movement of a user and indicates to an electronic device an initiation of an oral communication responsive to the sensing of the physical movement. In this manner, the user can interface with the electronic device substantially “hands-free”.

Turning now to the drawings, FIG. 1 illustrates one particular embodiment 100 of the present invention. The embodiment of FIG. 1 includes a headset 103 communicating with an electronic device 106 over a communications link 109. The communications link 109, in this particular embodiment, comprises a cable 112 and a connector 115 through which the headset 103 interfaces with the electronic device 106. The electronic device 106 may be, for instance, a computing apparatus 118 or, alternatively, a mobile phone 121. In alternative embodiments, the electronic device 106 may be any device capable of supporting voice-based features, including, but not limited to, voice recognition systems, audio recorders, and the like.

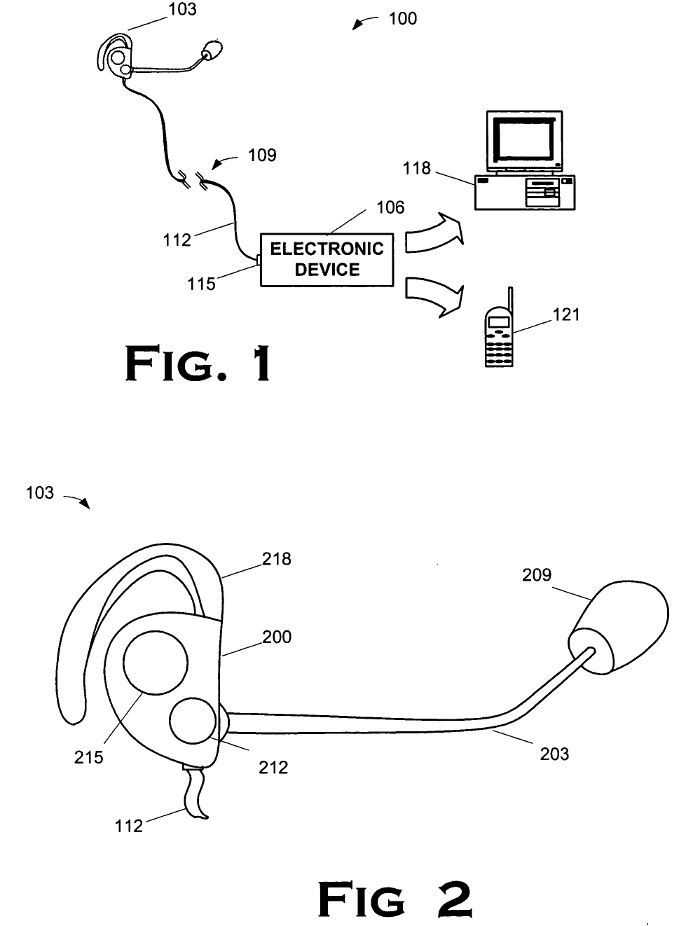

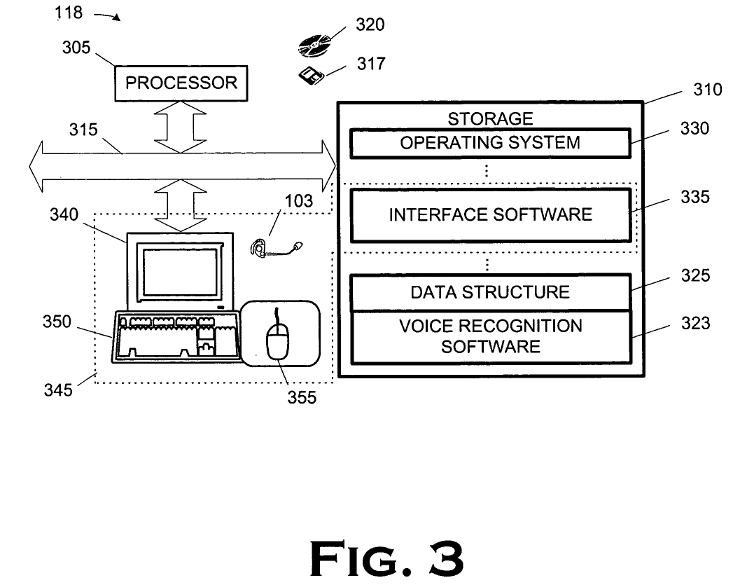

The headset 103 is shown in greater detail in FIG. 2. The headset 103 comprises a base 200, a boom 203 extending outwardly from the base 200, a microphone 209 mounted at a distal end of the boom 203, a sensor 212 associated with the base 200, a speaker 215, and an ear piece 218. The sensor 212 is capable of sensing a physical movement associated with an oral communication when the headset 103 is in use. In the illustrated embodiment, the ear piece 218 mounts the headset 103 to the user and further positions the base 200 to locate the sensor 212 in a desired location next to the user to sense the user's physical movement. In this particular embodiment, the sensor 212 is located in the region of the temporomandibular joint where the jaw meets the skull of the user. In alternative embodiments, the sensor 212 may be positioned in any desirable location where the user's desired movements, such as at least a portion of the user's facial movements, can be detected. The boom 203 may be used to position the microphone 209 relative to the user's mouth. The boom 203, microphone 209, and speaker 215 operate in conventional fashion.

In the illustrated embodiment, the sensor 212 is an electromyographic (“EMG”) sensor. EMG sensors are well known in some medical fields, and in particular in physical rehabilitative therapy and artificial prostheses. EMG sensors are placed on the surface of the skin to sense the electrical activity of muscles under the skin as the neurons fire to contract the muscles. As noted in the illustrated embodiment, the placement of the sensor 212 is in and around the region of the temporomandibular joint, which tends to be rich in musculature associated with speech. The sensor 212 senses the electrical activity of the muscles as the user initiates an oral communication, and generates a signal indicating that oral communication may be taking place.

In the illustrated embodiment, the base 200 and earpiece 218, cooperatively, position the sensor 212 so that it is able to sense the physical movement of the user. However, the base 200 is but one means by which this function may be implemented. Other means may become apparent to those in the art having the benefit of this disclosure. In one embodiment, the combination of the base 200, earpiece 218, and the boom 203 may provide a mechanism for positioning the microphone 209 to a desired location. However, this feature may be implemented in other ways as well, such as mounting a boom to a floor stand (not shown). Similarly, the ear piece 218 is but one means by which the base 200 can be positioned to locate the sensor 212 to sense the physical movement. A headband (not shown), for instance, may be used instead, and still other means may be employed.

In the illustrated embodiment, the sensor 212 senses a physical movement of the user associated with oral communication. The sensor 212 in this example is a transducer, and thus generates an output indicative of the movement, i.e., an electrical signal. In some embodiments, additional circuitry may be desired to condition the signal for compatibility with the input/output (“I/O”) protocol employed by the electronic device 106. Note, however, that the conditioning need not be complex because, in some instances, the signal may be used to simply indicate the initiation of the oral communication.

FIG. 3 illustrates a functional block diagram of the electronic device 106 as implemented in a computing apparatus 118 capable of providing voice-recognition capability. The computing apparatus 118 includes a processor 305 communicating with some storage 310 over a bus system 315. The storage 310 may include a hard disk and/or RAM and/or removable storage such as the magnetic disk 317 and the optical disk 320. In the illustrated embodiment, the storage 310 includes voice recognition software 323 and one or more data structures 325 for providing information for the voice recognition software 323. The voice recognition software 323 and data structures 325 may be implemented in any manner known to the art.

The storage 310 may also include an operating system 330 and interface software 335 that, in conjunction with a display 340 and the headset 103, constitute an operator interface 345. The operator interface 345 may also include optional peripheral I/O devices such as a keyboard 350 or a mouse 355 not previously shown. The processor 305 runs under the control of the operating system 330, which may be practically any operating system known to the art. The processor 305, under the control of the operating system 330, invokes the interface software 335 on startup so that the user can control the computing apparatus 118. The voice recognition software 323 is invoked by the processor 305 by the user through the operator interface 345 as described more fully below.

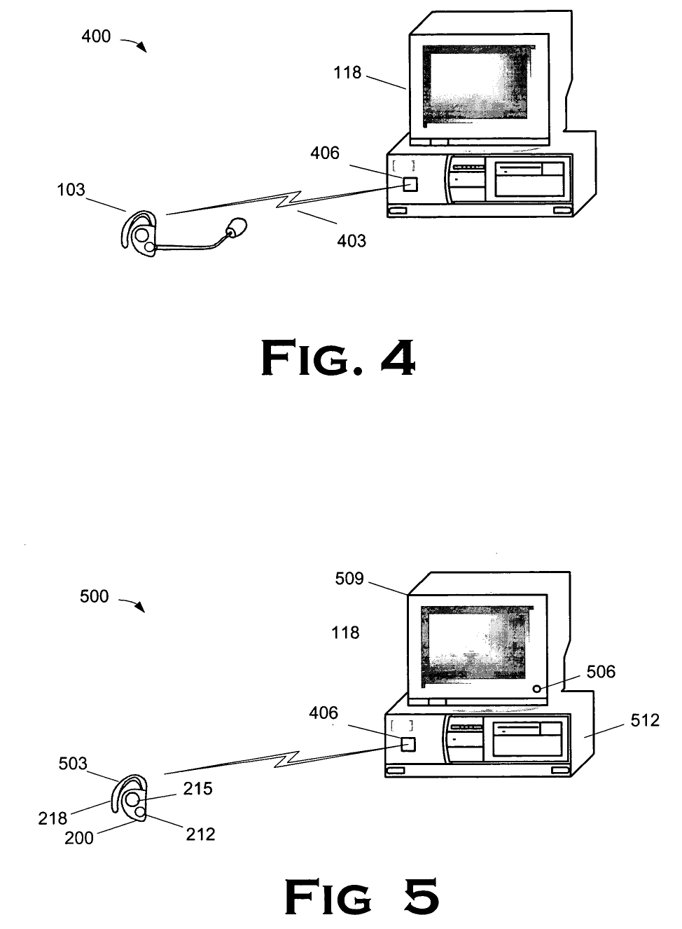

FIG. 4 depicts a second embodiment 400 alternative to that in FIG. 1 in which the headset 103 interfaces with the computing apparatus 118 over a wireless communications link 403. The computing arts include a number of well defined, well understood, and widely known techniques and protocols for wirelessly interfacing peripherals such as a mouse or a keyboard with a computing system. These same techniques can be utilized to implement the embodiment 400. In the illustrated embodiment, the headset 103 includes transmission circuitry and conditioning circuitry to provide conditioning for the signal generated by the sensor 212. Many computers already include a port such as the port 406 (usually located on the back) for wireless communications with peripheral devices that can be used for this purpose. In one embodiment, the headset 103 may be adapted to communicate with the computing apparatus 118 via the port 406.

FIG. 5 depicts a third embodiment 500 in which a headset 503 interfaces with the computing apparatus 118 over a wireless communications link 403, as in the embodiment 400 of FIG. 4. In this illustrated embodiment, the headset 503 comprises a base 200, a sensor 212, a speaker 215, and an earpiece 218. As can be seen, the headset 503 illustrated in FIG. 5 does not include the boom 203 (see FIG. 2) and the microphone 209 (see FIG. 2). Instead, in the illustrated embodiment 500, a microphone 506 is associated with the computing apparatus 118. In particular, the microphone 506 is mounted to the monitor 509, but may alternatively be mounted, for example, on a microphone stand (not shown) or the CPU box 512. Note that the headset 503 may also be employed with a mobile phone 121 (shown in FIG. 1) in some, alternative, embodiments, provided they have a “walkie-talkie” functionality.

Returning now to FIG. 1, in operation, the headset 103 is positioned on the head of the user. When the user begins speaking, a physical movement of the user associated with an oral communication (e.g., movement of the jaw) is sensed. In the illustrated embodiment, this movement is sensed by detecting the electrical impulses contracting the muscle effecting the physical movement. An indication that the oral communication has been initiated is then communicated to the electronic device 106 responsive to sensing the physical movement. The electronic device 106 then invokes the voice-based capability (e.g., the voice recognition software 323 in FIG. 3, or signal processing for transmission in a mobile phone) to process the oral communication received through the microphone 209.

Thus, depending on the implementation, the present invention can yield significant benefits over the state of the art. For instance, when used with a computer, the present invention can make the user interface more “hands-free” since the user no longer has to manually activate the voice-based capability. When used with a mobile phone, it can make the phone's use more safe by allowing the user to keep both hands on the steering wheel. Still other benefits and advantages in these and other implementations may become apparent to those in the art having the benefit of this disclosure.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A user interface for an electronic device, comprising:
a sensor capable of sensing a physical movement of a user associated with an oral communication and generating an indication thereof; and
an interface through which the sensor can provide the indication to the electronic device.

2. The user interface of claim 1, further comprising means for positioning the sensor to sense the physical movement.

3. The user interface of claim 1, further comprising a microphone capable of receiving the oral communication from the user.

4. The user interface of claim 1, wherein the sensor comprises an electromyographic sensor.

5. The user interface of claim 1, wherein the user interface includes a connector.

6. The user interface of claim 1, further comprising a transmitter for transmitting over a wireless communications link.

7. A headset for use with an electronic device, comprising:
a base;
a microphone associated with the base;
a sensor associated with the base and capable of sensing a physical movement associated with an oral communication and generating an indication thereof;
means by which the base can be positioned to locate the sensor to sense the physical movement; and
an interface through which the sensor can communicate the indication to an electronic device.

8. The headset of claim 7, wherein the base and the ear piece comprise a means for positioning the sensor.

9. The headset of claim 7, wherein the sensor comprises an electromyographic sensor.

10. The headset of claim 7, wherein the user interface includes a connector.

11. The headset of claim 7, wherein the user interface includes a wireless communications link.

12. The headset of claim 7, further comprising a speaker associated with the base.

13. The headset of claim 7, wherein the base-positioning means comprises an ear piece or a headband.

14. An apparatus, comprising:
an electronic device; and
a user interface, including:
a sensor capable of sensing a physical movement of a user associated with an oral communication and generating an indication thereof; and
an interface through which the sensor can communicate the indication to the electronic device.

15. The apparatus of claim 14, further comprising means for positioning the sensor to sense the physical movement.

16. The apparatus of claim 14, further comprising a microphone capable of receiving the oral communication from the user.

17. The apparatus of claim 14, wherein the sensor comprises an electromyographic sensor.

18. The apparatus of claim 14, wherein the user interface includes a connector.

19. The apparatus of claim 14, wherein the user interface includes a wireless communications link.

20. The apparatus of claim 14, wherein the electronic device comprises a computing apparatus or a mobile phone.

21. A method for interfacing with an electronic device, comprising:
sensing a physical movement of a user; and
indicating to an electronic device an initiation of an oral communication responsive to the sensing of the physical movement.

22. The method of claim 21, further comprising:
receiving the oral communication;
invoking a voice-based capability; and
processing the received oral communication response to sensing the initiation thereof.

23. The method of claim 21, further comprising initiating an oral communication with the electronic device.

24. The method of claim 21, further comprising positioning the sensor to sense the physical movement.

25. The method of claim 21, wherein sensing the physical movement includes sensing the electrical activity of the musculature effecting the physical movement.

26. The method of claim 21, wherein indicating to the electronic device includes generating an electrical signal.

27. The method of claim 26, wherein indicating to the electronic device includes conditioning the electrical signal.
